(19) United States
(12) Patent Application Publication
(10) Pub. No.: US 2010/0011165 A1
(43) Pub. Date: Jan. 14, 2010

(54) CACHE MANAGEMENT SYSTEMS AND METHODS

(75) Inventor: Frederic Rossi, Montreal (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/171,519

(22) Filed: Jul. 11, 2008

(51) Int. Cl. G06F 12/08

(52) U.S. Cl. 711/128; 711/E12.018

(57) ABSTRACT

A multi mode cache system that uses a direct mapped cache scheme for some addresses and an associative cache scheme for other addresses.

### TECHNICAL FIELD

The present invention relates to cache memory systems.

### BACKGROUND

A computer system typically comprises a processing unit for executing computer instructions and a memory system for storing data (e.g., the computer instructions and other data). The memory system typically includes a main memory component and one or more caches. The main memory component is larger than the cache, but also slower than the cache (i.e., the processor can retrieve data from the cache more quickly than it can retrieve the data from main memory, but the cache can't store as much data as the main memory). The cache functions as a temporary storage area that stores a subset of the data stored in the main memory. Typically, it stores the data most recently accessed from the main memory. Once this recently accessed data is stored in the cache, future use of that data can be made by accessing the cached copy rather than fetching the data from main memory. This improves data access time because, as mentioned above, the cache is faster than main memory. Cache, therefore, helps expedite data access that the processing unit would otherwise need to fetch from main memory. Hence, the goal of a cache system is to speed up access to data by exploiting program locality (either spatial locality to temporal locality).

A drawback of using a cache to speed up access to data is that the cache can be susceptible to trashing (e.g., highly used data may not be stored in the cache when needed because they are frequently overwritten). This can happen when the processing of information breaks the program locality. This may lead to a cache ping-pong problem or a cache invasion problem on multiprocessor architectures. Another problem faced by some cache architectures is energy consumption. Typical cache organizations, like associative or set associative organization, require repetitive parallel search for comparing address tags. This has a non negligible cost.

A scratch pad memory may be used to remedy both of the above mentioned disadvantages. The scratch pad memory is an on-chip memory which is mapped into the processor's address space. The advantages of the scratch pad memory are that it provides quick access to data and requires less energy per access due to the absence of tag comparison. However, there are also disadvantages to using scratch pad memory. For example, it must be implemented on chip as a separate mechanism, it requires compiler support to select either the data that will be moved into the scratch pad memory, and it doesn't exploit program temporal locality (once the data is selected to be in the scratch pad memory).

What is desired is a cache system that provides the advantages of an on-chip scratch pad memory while retaining the advantages of typical caches.

### SUMMARY

In one aspect, the invention provides a method for retrieving data from a cache and/or storing data in the cache. In some embodiments, this method includes the following steps: (1) determining whether a memory address is included in a set of memory addresses; (2) using bits from the memory address to directly access a slot in a cache if the memory address is within the set; and (3) for each of a plurality of slots in the cache, comparing a tag portion of the memory address with a tag stored in the slot if the memory address is not within the set (the plurality of slots in the cache may specified by a portion of the memory address). The step of determining whether the memory address is included in the set of memory addresses may include comparing a tag portion of the memory address to a first value and a second value to determine whether the tag portion is within a range defined by the first and second values. The first value may be stored in a first register and the second value may be stored in a second register. The method may further include executing a single assembly language instruction to load the first value in the first register and the second value in the second register. The step of comparing the tag portion of the memory address to a first of the plurality of slots and the step of comparing the tag portion of the memory address to a second of the plurality of slots may be performed in parallel.

When fetching data, the step of directly accessing the slot may include accessing a valid bit of the slot, and the method may further include determining whether the valid bit is raised; and fetching data from the slot if the valid bit is raised, otherwise fetching data from the memory location in memory that is identified by the memory address. When storing data, the step of directly accessing the slot may include accessing a dirty bit of the slot, and the method may further include storing in the memory location identified by the memory address the data currently stored in the slot and then storing new data in the slot.

In another aspect, the invention provides a method for evicting data from a cache. In some embodiments, the method includes the following steps: receiving a memory address and data to be stored; determining whether the memory address is included in a set of memory addresses; if the memory address is not within the set, then, for each of a set of slots in the cache, determining whether there is a cache hit; if there is no cache hit, then determining whether any of the slots in the set is not being currently used; if it is determined that all of the slots in the set are currently being used, then determining whether any of the slots in the set is mapped to a memory address that is not included in the set of memory addresses; if it is determined that one or more of the slots in the set is mapped to a memory address that is not included in the set of memory addresses, then selecting one of the one or more slots; and storing the data in the selected slot.

The step of determining whether there is a cache hit may include the following steps: comparing a tag portion of the memory address with a tag stored in one of the slots in the set; and determining whether a valid bit stored in said slot is raised if the tag portion of the memory address matches the tag stored in said slot.

The method may further include the steps of: selecting an unused slot if it is determined that at least one slot in the set is not currently being used; and storing the data in the selected slot. The method may also includes the steps of: writing to a memory location the data stored in the selected slot prior to storing the data to be stored in the selected slot if a dirty bit of the selected slot is raised, and selecting one of the plurality of slots according to a predefined algorithm (e.g., LRU, FIFO, etc.) if it is determined that each of the slots in the set is mapped to a memory address that is included in the set of memory addresses.

In another aspect, the present invention provides an improved computer system. In some embodiments, the computer system includes: a processor; a cache comprising a plurality of slots; a memory; and a cache controller, wherein the cache controller is configured to: (a) determine whether a memory address is included in a set of memory addresses, (b) use bits from the memory address to directly access a slot in the cache in response to determining that the memory address is included in the set of memory addresses, and (c) compare a tag portion of the memory address with tags from a set of two or more slots of the cache in response to determining that the memory address is not included in the set of memory addresses. The set of two or more slots may consist of the plurality of slots or a subset of the plurality of slots. The cache controller may be configured to determine whether the memory address is included in the set of memory addresses by determining whether the memory address falls within a specified range of memory addresses. The computer system may further include a first register for storing a value defining one end of the range of memory addresses and a second register for storing a value defining the other end of the range of memory addresses. The first register may store a memory address and the second register may store a range size value, wherein the memory address stored in the first register defines either the low end or high end of the memory address range and the range size value defines the size of the memory address range. The processor may have an instruction set that includes a load register instruction for loading values into the first and second registers, and the load register instruction may have the following format: opcode operand1, operand2, wherein the processor may be configured such that when the processor executes the load register instruction the processor stores operand1 in the first register and operand2 in the second register. The cache controller may include a comparator and the comparator is configured to compare a tag portion of the memory address to the value in the first register.

In another embodiment, the computer system includes a processor; a first register; a second register; a cache comprising a plurality of slots; a memory; and a cache controller, wherein the processor has an instruction set and the instruction set includes a load register instruction for loading values into the first and second registers, and the cache controller is configured to determine whether a memory address is included in a set of memory addresses by using the values stored in the first and second registers.

In another aspect, the invention provides a multi mode cache system. The cache system, in some embodiments, includes: (1) a cache comprising a plurality of slots and (2) a cache controller, wherein the cache controller is configured to: (a) determine whether a memory address is included in a set of memory addresses, (b) use bits from the memory address to directly access a slot in the cache in response to determining that the memory address is included in the set of memory addresses, and (c) compare a tag portion of the memory address with tags from a set of two or more slots of the cache in response to determining that the memory address is not included in the set of memory addresses.

The above and other aspects and embodiments are described below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements.

FIG. 1 is a high-level block diagram of a data processing system according to some embodiments of the invention.

FIG. 2 is a flow chart illustrating a process according to some embodiments of the invention.

FIGS. 3a-d illustrate various different address formats.

FIG. 4 is a flow chart illustrating a process according to some embodiments of the invention.

### DETAILED DESCRIPTION

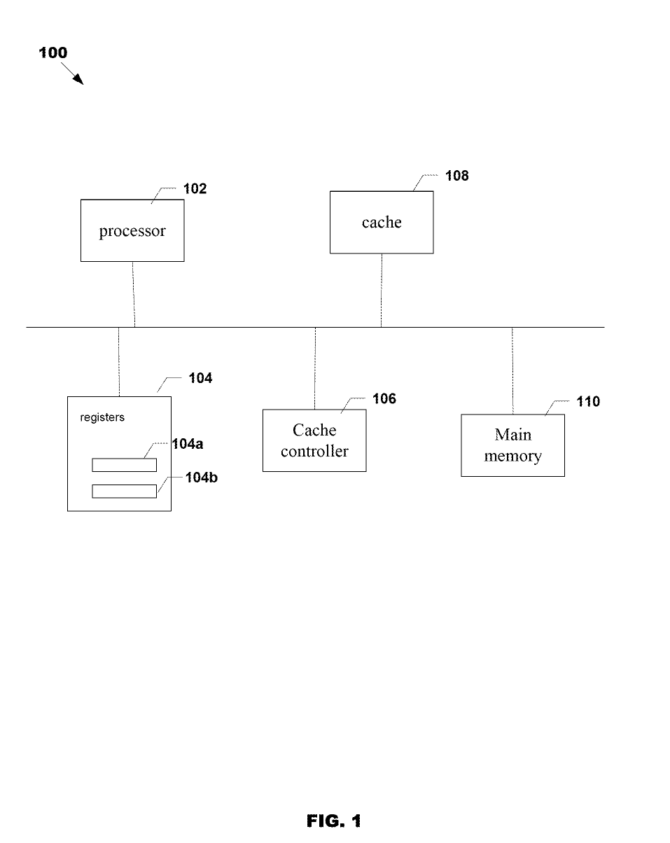

Referring to FIG. 1, FIG. 1 is a high-level block diagram of a data processing system 100 according to some embodiments of the invention. As shown, data processing system 100 may include: a processor 102 (e.g., a microprocessor), registers 104 (e.g., registers 104a and 104b), a multi mode cache controller 106, a cache 108 and main memory 110 (e.g., dynamic random access memory DRAM). Cache 108 may be a conventional cache. That is cache 108 may include a number of slots (e.g., 128 slots), where each slot stores a valid bit, a tag, and a block of data or “cache line”. While the components are shown in separate boxes, they need not be implemented on separate chips.

According to some embodiments of the invention, cache controller 106 is configured to use an associative scheme (set associative or fully associative) to store certain data in cache 108 and is configured to use a direct way access scheme to store certain other data in cache 108. Hence, controller 106 may be referred to as a multi mode cache controller. More specifically, cache controller 106 is configured to use the direct way access scheme for data stored in (or destined for) certain, predefined locations in main memory 110 and is configured to use the associative scheme for all other data stored in (or destined for) main memory 110.

In some embodiments of the invention, registers 104a and 104b store data that defines the locations in main memory 110 (i.e., the predefined set of main memory addresses) for which the direct way access scheme will be employed, however, the predefined set of memory addressed may be defined in other ways that do not use registers. In one embodiment, the data stored in registers 104a and 104b define an address range and all addresses that fall within that range will be directly accessed in the cache, rather than associatively accessed in the cache, wherein all address outside of the range will be associatively accessed in the cache. In some embodiments, register 104a stores a low memory address and register 104b stores a high memory address. These two addresses define the address range. This range may be referred to as the direct tag range. In other embodiments, the direct tag range may be defined by storing in register 104a an address that identifies the beginning (or end) of the range and storing in register 104b a value identifying the size of the range. In some embodiments, there may be multiple pairs of registers for defining multiple direct tag ranges. In some embodiments, only one register is used to define the set of memory addresses for which the direct way access scheme will be employed. In such embodiments, the one register may store a value identifying an address and the size of the address range may be hard coded (e.g., stored in ROM or in another device that does not require the use of the cache). And, in some embodiments, no registers are used to define the set of memory addresses because information identifying the set may be hard coded (e.g., stored in ROM or a circuit can be designed to take an address or tag as input and produce a value indicating whether or not the address or tag is an address/tag for which the direct way access scheme should be used).

In some embodiments, an instruction to load registers 104a and 104b is provided so that an application (e.g., operating system kernel) can set the address range. This instruction may be named “ldtg” (load direct tags). The format of the ldtg instruction may be as follows: ldtg low_addr, hi_addr. When this instruction is executed by processor 102, processor 102 may store the value “low_addr” in register 104a and may store the value “hi_addr” in register 104b. In other embodiments, when this instruction is executed by processor 102, processor 102 may store a portion of the value “low_addr” in register 104a (e.g., the x high order bits of low_addr may be stored) and may store a portion of the value “hi_addr” in register 104b. In other embodiments, the format of the ldtg instruction may be as follows: ldtg addr, size. When this instruction is executed by processor 102, processor 102 may store the value “addr” in register 104a (or a portion of the value addr) and may store the value “size” in register 104b, where addr represents a start address or an end address and size represents the size of the range.

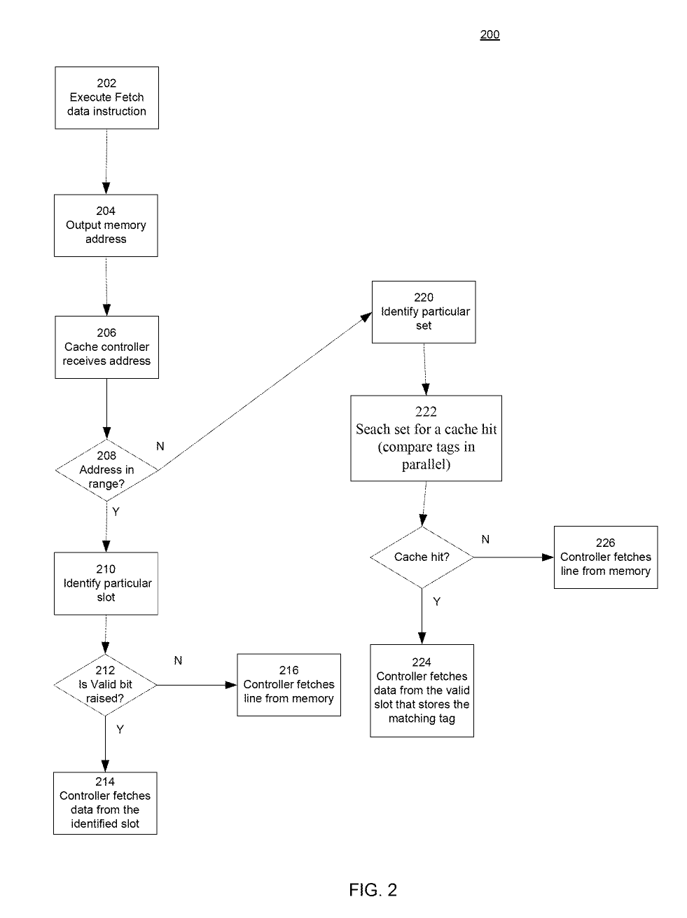

Referring now to FIG. 2, FIG. 2 is a flow chart illustrating a process 200, according to some embodiments, for fetching data. Process 200 may begin in step 202, where processor 102 executes an instruction to fetch data putatively stored in a specified location in main memory 110. This causes processor 102 to output an address associated with the memory location (e.g., the physical address of the memory location or a virtual address of the memory location) (step 204). This address is received by cache controller 106 (step 206).

Next (step 208) cache controller 106 determines whether the address is in the address range defined by registers 104a,b. For example, controller 106 may have means for performing this function (the means may include one or more comparators). In some embodiments, controller 106 uses a comparator to compare high order bits of the address (a.k.a., the “address tag” or “tag”) to the values stored in registers 104a,b to determine whether the tag is greater than or equal to the value stored in register 104a and less than or equal to the value stored in register 104b (i.e., to determine whether the address is within the address range). For example, if the address is a 64 bit address, then in step 208 controller 106 may compare bits x to 63 of the address to the values in registers 104a,b, where x>0. Controller 106 may include a latch to store the result of the determination (e.g., the result of the comparison of the address tag with the data in the registers).

If the tag is determined to be within the address range, then process 200 may proceed to step 210, otherwise it may proceed to step 220.

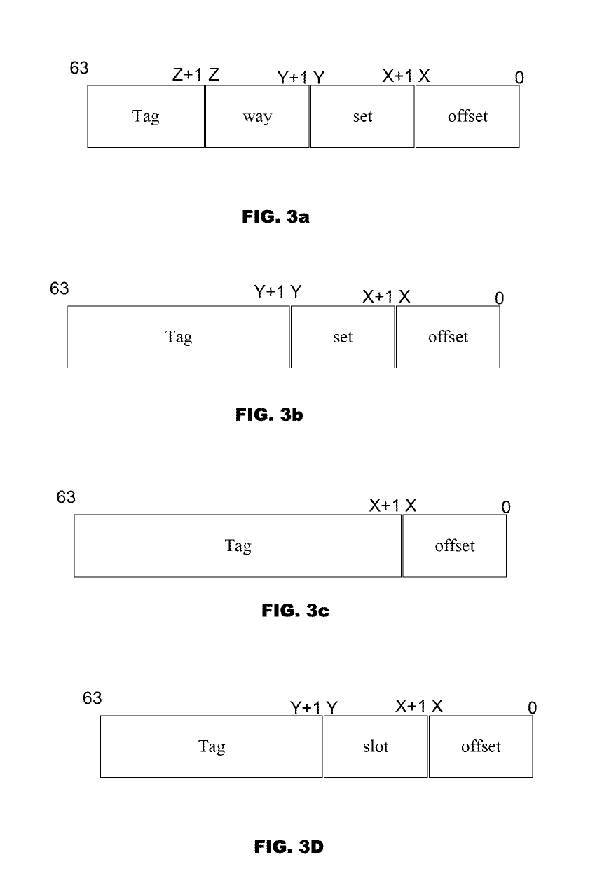

In step 210, controller 106 identifies a particular slot of cache 108 based on the address received in step 206. For example, the particular slot of cache 108 may by identified from some sequence of bits from the address. This feature is illustrated in FIG. 3a, which shows a direct way access address format according to some embodiments. As shown in FIG. 3a, the address of the data to be fetched may be a 64 bit address and controller 106 may treat bits 0 to x as an offset field, bits x+1 to y as a set field, bits y+1 to z as a slot field or “way” field, and bits z+1 to 63 as a tag. In this example, the way bits and the set bits (i.e., bits x+1 to z) specify a unique slot in cache 108. For example, the set bits may identify a unique set of slots and the way field may identify a particular slot within the identified set. Thus, controller 106 may identify the particular slot of cache 108 by processing bits x+1 to z of the address received in step 206. FIG. 3d illustrates a direct way access address format according to another embodiment. As shown in FIG. 3d, the address of the data to be fetched may be a 64 bit address and controller 106 may treat bits 0 to x as an offset field, bits x+1 to y as a slot field, and bits y+1 to 63 as a tag. In this example, the slot bits (i.e., bits x+1 to y) specify a unique slot in cache 108. Thus, controller 106 may identify the particular slot of cache 108 by processing bits x+1 to y of the address received in step 206.

In step 212, controller 106 directly accesses the slot identified in step 210, compares the tag stored in the slot to the tag portion of the address (e.g., bits z+1 to 63 of the address) to see if they match, and checks whether the valid bit of the slot is set to raised. If the valid bit is raised and the tags match, this indicates a cache hit and controller 106 will fetch the requested data from the slot (step 214). For example, the offset is used to fetch the data from the cache line stored in the identified slot. In step 216, a line including the requested data is fetched from main memory 110 and stored in the cache line field of the identified slot.

Referring now to step 220, in step 220 controller 106 identifies a particular set of cache slots. In some embodiments, called set associative cache organizations, the particular set may be identified by a portion of the address received in step 206. This feature is illustrated in FIG. 3b, which shows an address format according to some embodiments. As shown in FIG. 3b, the address of the data to be fetched may be a 64 bit address and controller 106 may treat bits 0 to x as an offset field, bits x+1 to y as a set field, and bits y+1 to 63 as a tag. In this example, the set bits (i.e., bits x+1 to y) specify a unique set of slots in cache 108. Thus, controller 106 may identify the particular set by processing bits x+1 to y of the address received in step 206. Another possible address format is shown in FIG. 3c. In this embodiment, called fully associative cache organizations, there is only an offset field and a tag field, accordingly the set of slots includes all of the slots of the cache and controller 106 does not have to process any bits of the address in order to identify the set because there is only one set.

In step 222, controller compares in parallel the address tag (e.g., bits y+1 to 63) with each tag stored in a slot that is included in the identified set, in a manner conventionally known. If the address tag matches a tag stored in one of the slots included in the set and the valid bit for that slot is raised, then this indicates a cache hit and controller 106 will fetch the requested data from the slot (step 224), otherwise a line including the requested data is fetched from main memory 110 and stored in one of the slots in the set (step 226) according to known methods.

In the above manner, certain memory tags are handled using a direct way access scheme, whereas the other tags are handled using the default associative scheme (fully associative or set associative). As is seen from the above, the choice to use one or the other schemes is made by the programmer via registers 104a and 104b, which defines the addresses for which controller 106 will use the direct way access scheme. But, in some embodiments, whether the cache is set or fully associative cannot be changed by the programmer and this is a hardware dependency of which the programmer is aware.

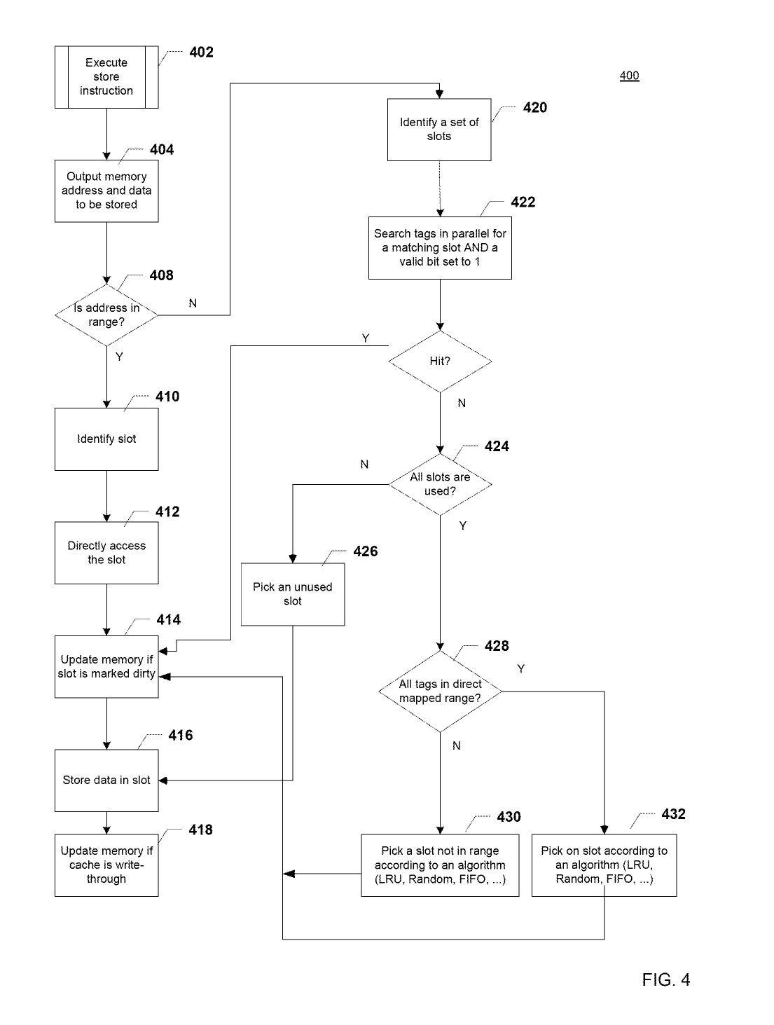

Referring now to FIG. 4, FIG. 4 is a flow chart illustrating a process 400, according to some embodiments, for storing data. Process 400 may begin in step 402, where processor 102 executes an instruction to store data in a certain location in main memory 110. This causes processor 102 to output an address associated with the memory location and the data to be stored (step 404). This address is received by cache controller 106.

Next (step 408) cache controller 106 determines whether the address is in the address range defined by registers 104a,b. For example, as discussed above, controller 106 may have means for performing this function (the means may include one or more comparators). If the address is determined to be within the address range, then process 400 may proceed to step 410, otherwise it may proceed to step 420.

In step 410, controller 106 identifies a particular slot of cache 108 based on the address output in step 404. For example, as discussed above with respect to step 210 of process 200, the particular slot of cache 108 may by identified from some sequence of bits from the address.

In step 412, controller 106 directly accesses the slot identified in step 410 (e.g., reads the dirty bit of the slot). In step 414, main memory 110 is updated if the slot is marked as dirty (e.g., the dirty bit is raised). In step 416, the data is stored in the slot. In step 418, main memory 110 is updated if a write-through flag is raised.

Referring now to step 420, in step 420 controller 106 identifies a particular set of cache slots. As discussed above with respect to step 220 of process 200, the particular set may be identified by a portion of the address output in step 404 or the set may include all of the slots of cache 108.

In step 422, controller compares in parallel the tag portion of the address with each tag stored in a slot that is included in the identified set. If the address tag matches a tag stored in one of the slots included in the set and the valid bit for that slot is raised, then this indicates a cache hit and process 400 will proceed to step 414. If there is a cache miss, process 400 proceeds to step 424.

In step 424, controller 106 determines whether there are any unused slots in the set (i.e., whether there are any slots in the set for which the valid bit of the slot is not raised). If there is an unused slot in the set, then process 400 proceeds to step 426, otherwise it proceeds to step 428. In step 426, an unused slot is selected and then process 400 proceeds to step 416 where the data is stored in the selected unused slot. In step 428, for each slot in the set, controller 106 determines whether the tag stored in the slot is within the direct mapped range (e.g., the range specified by the data in registers 104a and 104b) to determine whether there are any tags in the set that are not within the range. If there are tags in the set that are not within the range, the process proceeds to step 430, otherwise it proceeds to step 432.

In step 430, controller 106 selects a slot containing a tag that is not within the direct tag range and then the process proceeds to step 416 where the data is stored in the selected slot. In step 432, controller 106 selects a slot and then the process proceeds to step 416 where the data is stored in the selected slot. Controller 106 may use a well known cache eviction scheme to select the slots in steps 430 and 432. For example, the slots may be selected based on a first-in first-out scheme, least recently used scheme, etc.

While various embodiments of the present invention have been described above, it should be understood that they have been presented by way of example only, and not limitation. Thus, the breadth and scope of the present invention should not be limited by any of the above-described exemplary embodiments.

Additionally, while the processes described above and illustrated in the drawings are shown as a sequence of steps, this was done solely for the sake of illustration. Accordingly, it is contemplated that some steps may be added, some steps may be omitted, and the order of the steps may be re-arranged.

What is claimed is:

1. A method for retrieving data from a cache and/or storing data in the cache, comprising:
determining whether a memory address is included in a set of memory addresses;
if the memory address is within the set, then using bits from the memory address to directly access a slot in the cache; and
if the memory address is not within the set, then, for each of a plurality of slots in the cache, comparing a tag portion of the memory address with a tag stored in the slot.

2. The method of claim 1, wherein the step of determining whether the memory address is included in a set of memory addresses comprises comparing a tag portion of the memory address to a first value and a second value to determine whether the tag portion is within a range defined by the first and second values.

3. The method of claim 2, wherein the first value is stored in a first register and the second value is stored in a second register.

4. The method of claim 3, further comprising executing a single assembly language instruction to load the first value in the first register and the second value in the second register.

5. The method of claim 1, wherein the step of comparing the tag portion of the memory address to a first of the plurality of slots and the step of comparing the tag portion of the memory address to a second of the plurality of slots are performed in parallel.

6. The method of claim 1, wherein the plurality of slots in the cache is specified by a portion of the memory address.

7. The method of claim 1, wherein the step of directly accessing the slot comprises accessing a valid bit of the slot.

8. The method of claim 7, further comprising:
determining whether the valid bit is raised; and
fetching data from the slot if the valid bit is raised, otherwise fetching data from the memory location in memory that is identified by the memory address.

9. The method of claim 1, wherein the step of directly accessing the slot comprises accessing a dirty bit of the slot and the method further includes the step of storing in the memory location identified by the memory address the data currently stored in the slot and then storing new data in the slot.

10. A method for storing data in a cache, comprising:
receiving a memory address and the data to be stored;
determining whether the memory address is included in a set of memory addresses;
if the memory address is not within the set, then, for each of a set of slots in the cache, determining whether there is a cache hit;
if there is no cache hit, then determining whether any of the slots in the set is not being currently used;
if it is determined that all of the slots in the set are currently being used, then determining whether any of the slots in the set is mapped to a memory address that is not included in the set of memory addresses;
if it is determined that one or more of the slots in the set is mapped to a memory address that is not included in the set of memory addresses, then selecting one of the one or more slots; and
storing the data in the selected slot.

11. The method of claim 10, wherein the step of determining whether there is a cache hit comprises:
comparing a tag portion of the memory address with a tag stored in one of the slots in the set; and
determining whether a valid bit stored in said slot is raised if the tag portion of the memory address matches the tag stored in said slot.

12. The method of claim 11, further comprising:
selecting an unused slot if it is determined that at least one slot in the set is not currently being used; and
storing the data in the selected slot.

13. The method of claim 10, further comprising writing to a memory location the data stored in the selected slot prior to storing the data to be stored in the selected slot if a dirty bit of the selected slot is raised.

14. The method of claim 10, further comprising selecting one of the plurality of slots according to a predefined algorithm if it is determined that each of the slots in the set is mapped to a memory address that is included in the set of memory addresses.

15. A computer system, comprising:
a processor;
a cache comprising a plurality of slots;
a memory; and
a cache controller, wherein the cache controller is configured to: (a) determine whether a memory address is included in a set of memory addresses, (b) use bits from the memory address to directly access a slot in the cache in response to determining that the memory address is included in the set of memory addresses, and (c) compare a tag portion of the memory address with tags from a set of two or more slots of the cache in response to determining that the memory address is not included in the set of memory addresses.

16. The computer system of claim 15, wherein the set of two or more slots consists of the plurality of slots or a subset of the plurality of slots.

17. The computer system of claim 15, wherein the cache controller is configured to determine whether the memory address is included in the set of memory addresses by determining whether the memory address falls within a specified range of memory addresses.

18. The computer system of claim 17, further comprising a first register for storing a value defining one end of the range of memory addresses and a second register for storing a value defining the other end of the range of memory addresses.

19. The computer system of claim 18, wherein the first register stores a memory address and the second register stores a range size value, wherein the memory address stored in the first register defines either the low end or high end of the memory address range and the range size value defines the size of the memory address range.

20. The computer system of claim 18, wherein the processor has an instruction set and the instruction set includes a load register instruction for loading values into the first and second registers.

21. The computer system of claim 20, wherein the load register instruction has the following format: opcode operand1, operand2.

22. The computer system of claim 21, wherein the processor is configured such that when the processor executes the load register instruction the processor stores operand1 in the first register and operand2 in the second register.

23. The computer system of claim 18, wherein the cache controller comprises a comparator and the comparator is configured to compare a tag portion of the memory address to the value in the first register.

24. The computer system of claim 15, wherein the set of two or more slots is defined by a portion of the memory address.

25. A computer system, comprising:
a processor;
a first register;
a second register;
a cache comprising a plurality of slots;
a memory; and
a cache controller, wherein
the processor has an instruction set and the instruction set includes a load register instruction for loading values into the first and second registers, and
the cache controller is configured to determine whether a memory address is included in a set of memory addresses by using the values stored in the first and second registers.

26. The computer system of claim 25, wherein the cache controller is further configured to (a) use bits from the memory address to directly access a slot in the cache in response to determining that the memory address is included in the set of memory addresses and (b) compare a tag portion of the memory address with tags from a set of two or more slots of the cache in response to determining that the memory address is not included in the set of memory addresses.

27. The computer system of claim 26, wherein the load register instruction has the following format: opcode operand1, operand2.

28. The computer system of claim 27, wherein the processor is configured such that when the processor executes the load register instruction the processor stores operand1 in the first register and operand2 in the second register.

29. The computer system of claim 25, wherein the cache controller comprises a comparator and the comparator is configured to compare a tag portion of the memory address to the value in the first register.

30. A multi mode cache system, comprising:
a cache comprising a plurality of slots; and
a cache controller, wherein the cache controller is configured to: (a) determine whether a memory address is included in a set of memory addresses, (b) use bits from the memory address to directly access a slot in the cache in response to determining that the memory address is included in the set of memory addresses, and (c) compare a tag portion of the memory address with tags from a set of two or more slots of the cache in response to determining that the memory address is not included in the set of memory addresses.

31. The cache system of claim 30, wherein the cache controller is configured to determine whether the memory address is included in the set of memory addresses by determining whether the memory address falls within a specified range of memory addresses.

32. The cache system of claim 31, further comprising a first register for storing a value defining one end of the range of memory addresses and a second register for storing a value defining the other end of the range of memory addresses.

33. The cache system of claim 32, wherein the first register stores a memory address and the second register stores a range size value, wherein the memory address stored in the first register defines either the low end or high end of the memory address range and the range size value defines the size of the memory address range.

34. The cache system of claim 32, wherein the cache controller comprises a comparator and the comparator is configured to compare a tag portion of the memory address to the value in the first register.
